(19) United States
(12) Patent Application Publication
(10) Pub. No.: US 2004/0018014 A1
(43) Pub. Date: Jan. 29, 2004

(54) Digital camera using internal memory and disconnectable external memory

(75) Inventor: Takahiro Doi, Hachoji-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/404,520

(22) Filed: Apr. 1, 2003

(30) Foreign Application Priority Data
Apr. 5, 2002 (JP) 2002-104343
Apr. 9, 2002 (JP) 2002-106887

(51) Int. Cl. G03B 17/48

(52) U.S. Cl. 396/429

(57) ABSTRACT

A digital camera from which an external memory capable of storing image data imaged by an imaging section is disconnectable has a user-information reading section and an operation-stage deciding section. The user-information reading section reads user information previously stored in the external memory when the external memory is mounted. The operation-state deciding section decides an operation state of the digital camera based on the user information read by the user-information reading section.

### CROSS-REFERENCE TO RELATED APPLICATIONS

This application is based upon and claims the benefit of priority from the prior Japanese Patent Applications No. 2002-104343, filed Apr. 5, 2002; and No. 2002-106887, filed Apr. 9, 2002, the entire contents of which are incorporated herein by reference.

### BACKGROUND OF THE INVENTION

1. Field of the Invention

The present invention relates to a digital camera capable of using not only an internal memory built in a camera body but also an external memory disconnectable from the camera body.

2. Description of the Related Art

In general, a digital camera itself cannot restrict that a user uses the digital camera.

Therefore, a person who does not have the right of using the digital camera or a person who does not completely understand how to use the camera may operate the digital camera without permission to photograph.

Thereby, digital image data already photographed by the digital camera may be erroneously erased, the capacity of the internal memory of the digital camera may be wasted, or a battery may be exhausted.

Moreover, when two or more users use one digital camera, it inevitably depends on only the memory of each photographer to determine which user photographed image data belong to.

Furthermore, when the digital camera has a photographing function using a silver halide film, a person who does not have the right of using the camera or a person who does not completely understand how to use the camera may erroneously photograph and thereby, a film or battery may be exhausted.

As a prior art, Jpn. Pat. Appln. KOKAI Publication No. 10-243275 discloses a digital camera corresponding to an internal memory built in the camera and an external memory disconnectable from the digital camera.

The digital camera comprises a digital imaging system for generating first digital image data, a first memory for storing the first digital image data, a fixed-memory or disconnectable-memory interface connector for accepting a disconnectable memory element, and a processor for controlling transfer of the first digital image data from the first memory to the fixed- or disconnectable-memory interface connector.

The processor generates second digital image data having a resolution lower than that of the first digital image data to display a list of contracted images on a display screen.

The second digital image data displayed on the display screen is stored in a second memory as contracted images and configured as album images held in the camera until the images are particularly erased by a camera operator.

The art disclosed in Jpn. Pat. Appln. KOKAI Publication No. 10-243275 transfers digital image data from the camera to the disconnectable external memory, and stores the digital image data in the disconnectable external memory.

### BRIEF SUMMARY OF THE INVENTION

According to a first aspect of the present invention, there is provided a digital camera from which an external memory capable of storing image data imaged by an imaging section is disconnectable, comprising:

a user-information reading section which reads user information previously stored in the external memory when the external memory is mounted; and

an operation-state deciding section which decides an operation state of the digital camera based on the user information read by the user-information reading section.

According to a second aspect of the present invention, there is provided a digital camera from which an external memory capable of storing image data imaged by an imaging section is disconnectable, comprising:

an internal memory capable of storing the image data imaged by the imaging section; and

a control section which makes the external memory preferentially store the image data in a state in which the external memory is mounted.

According to a third aspect of the present invention, there is provided a digital camera from which an external memory capable of storing image data imaged by an imaging section is disconnectable, comprising:

an internal memory capable of storing the image data imaged by the imaging section;

a display section which displays the image data stored in the internal memory; and

a determining section which determines whether or not the image data imaged by the imaging section is image data immediately after imaged,

wherein, when the determining section determines that the image data is the image data immediately after imaged, the display section displays the image data imaged by the imaging section, and when the determining section determines that the image data is not the image data immediately after imaged, the display section displays ordinary display image data previously stored in the internal memory.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A shows an external configuration of a digital camera to which the present invention is applied, which is a perspective view showing a state in which a disconnectable external memory is connected from the bottom to the digital camera, viewed from the front of the digital camera;

FIG. 1B is a perspective view showing a state in which the external memory in FIG. 1A is connected to the digital camera, viewed from the front of the digital camera;

FIG. 1C is a perspective view showing a state in which the external memory in FIG. 1A is connected to the digital camera, viewed from the rear of the digital camera;

FIG. 2A shows an external configuration of another digital camera to which the present invention is applied, which is a perspective view showing a state in which a disconnectable external memory is connected to the digital camera from the side face of the camera, viewed from the front of the digital camera;

FIG. 2B is a perspective view showing a state in which the external memory in FIG. 2A is connected to the side face of the camera, viewed from the front of the camera;

FIG. 3A shows an external configuration of still another digital camera to which the present invention is applied, which is a perspective view showing a state in which a disconnectable external memory is connected to the digital camera from the back, viewed from the rear;

FIG. 3B is a perspective view showing a state in which the external memory in FIG. 3A is connected into the digital camera, viewed from the rear of the digital camera;

FIG. 4A is a perspective view showing an external memory for use in a digital camera to which the present invention is applied and having a push-switch-type authentication-information input section;

FIG. 4B is a perspective view showing an external memory for use in a digital camera to which the present invention is applied and having a dial-type authentication-information input section;

FIG. 5 is a block diagram showing a connective configuration of a digital camera of a first embodiment of the present invention with an external memory;

FIG. 6 is a flowchart shown to explain operations of the digital camera in FIG. 5;

FIG. 7 is a flowchart shown to explain operations of the digital camera in FIG. 5;

FIG. 8 is a schematic view showing a configuration of an internal memory of the digital camera shown in FIG. 5;

FIG. 9 is a flowchart shown to explain operations of a digital camera of a second embodiment of the present invention;

FIG. 10 is a flowchart shown to explain operations of the digital camera of the second embodiment of the present invention for always displaying display image data on the digital camera; and

FIG. 11 is an illustration showing a state in which a user of the digital camera of the second embodiment arbitrarily displays ordinary display image data on the LCD of the camera and appreciates the data.

### DETAILED DESCRIPTION OF THE INVENTION

Reference will now be made in detail to the presently preferred embodiments of the invention as illustrated in the accompanying drawings, in which like reference numerals designate like or corresponding parts.

Embodiments of the present invention will be described below by referring to the accompanying drawings.

First, an external configuration of a digital camera to which the present invention is applied and an external memory disconnectable from the digital camera are described below.

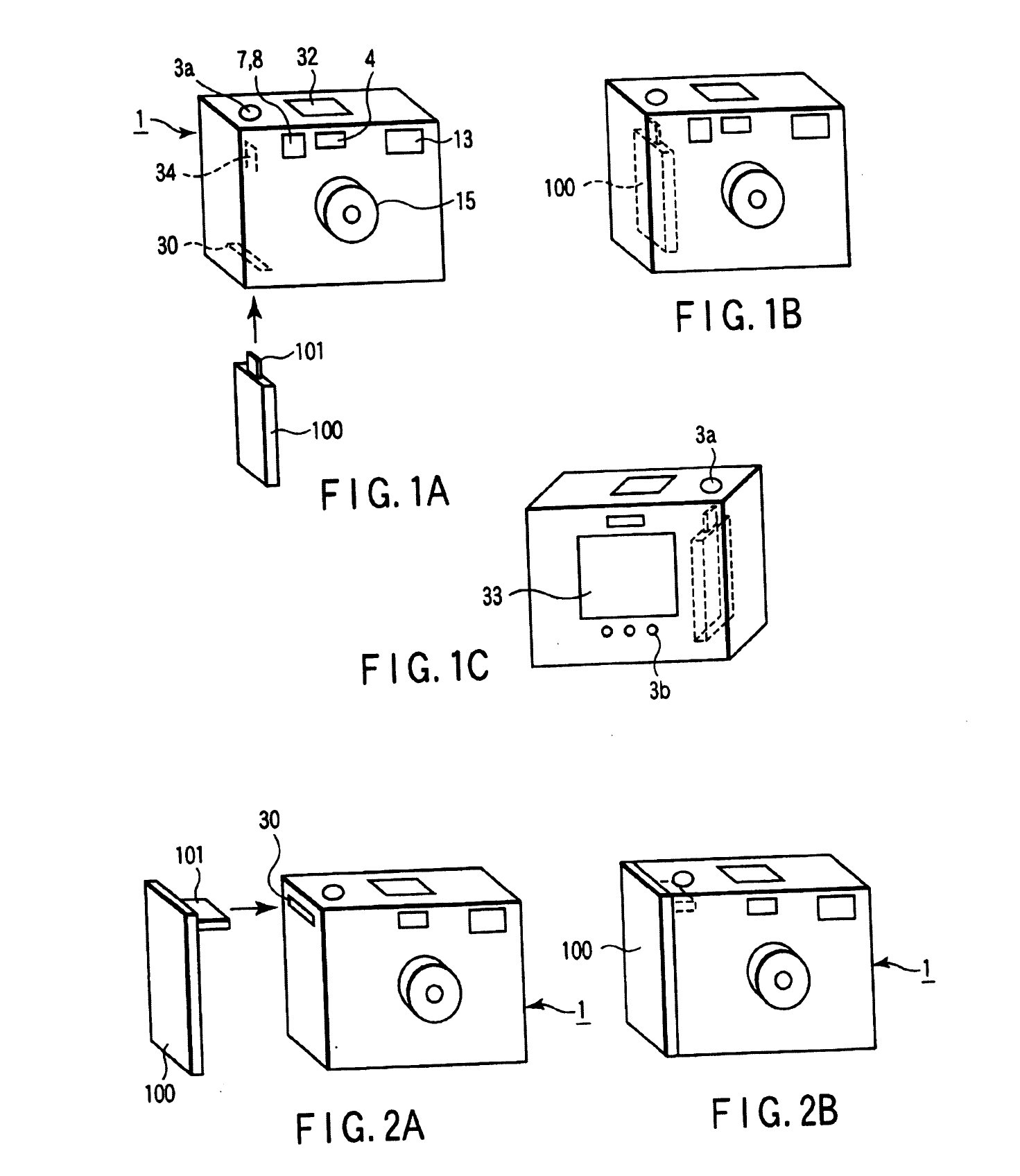

FIGS. 1A, 1B, and 1C are views for explaining a digital camera to which the present invention is applied.

FIG. 1A shows an external configuration of the digital camera 1 to which the present invention is applied, which is a perspective view showing a state in which a disconnectable external memory 100 is connected to the digital camera 1 from the bottom, viewed from the front of the digital camera 1.

FIG. 1B is a perspective view showing a state in which the external memory 100 in FIG. 1A is connected to the digital camera 1, viewed from the front of the digital camera 1.

FIG. 1C is a perspective view showing a state in which the external memory 100 in FIG. 1A is connected to the digital camera 1, viewed from the rear of the digital camera 1.

Moreover, the digital camera 1 shown in FIGS. 1A, 1B, and 1C has a silver halide film camera function (silver-salt imaging means) and a digital camera function (digital imaging means) as a digital camera to which the present invention is applied.

That is, as shown in FIG. 1A, the digital camera 1 has a photographing lens (lens driving section and lens) 15, a flashlight generating section 13, a distance measuring section 7, and a light measuring section 8 at the front thereof.

Moreover, an operation switch 3a operated when the silver-film camera function is used and a number-of-frames/camera-mode-display section 32 for displaying the number of frames of a film and a camera mode are arranged at the upper face of the digital camera 1.

Furthermore, a slit-like inserting section 30 capable of connecting the external memory 100 is set to the bottom of the digital camera 1.

Also, a connecting section 101 connectable with the digital camera 1 is protruded to the upper face of the external memory 100.

By inserting the external memory 100 from the inserting section 30, the connecting section 101 of the external memory 100 is connected with a connecting section 34 built in the digital camera 1.

The external memory 100 serves as storing means externally mounted to the digital camera 1 to store the data imaged by the digital camera function and the like.

As shown in FIG. 1B, though the external memory 100 is mounted so as to be completely included in the digital camera 1, it is also allowed to set the external memory 100 such that a part of the external memory 100 is mounted so as to protrude to the outside of the digital camera 1.

As shown in FIG. 1C, a digital image display section 33 and an operation switch 3b operated to use a digital camera function are arranged on the back of the digital camera 1.

The operation switch 3b is used to display, erase, or move photographed digital image data.

FIGS. 2A, 2B and 2C are views for explaining another digital camera to which the present invention is applied.

FIG. 2A shows an external configuration of another digital camera 1 to which the present invention is applied, which is a perspective view showing a state in which the disconnectable external memory 100 is connected to the digital camera 1 from the side face of the digital camera 100, viewed from the front of the digital camera 1.

FIG. 2B is a perspective view showing a state in which the external memory 100 in FIG. 2A is connected to the side face of the digital camera 1, viewed from the front of the digital camera 1.

That is, as shown in FIG. 2A, the inserting section 30 is arranged to the side face of the digital camera 1.

Moreover, the connecting section 101 is protruded to the side face of the disconnectable external memory 100 of the digital camera 1.

Furthermore, a connecting section (not shown) connectable with the connecting section 101 is provided in the digital camera 1.

In the case of the above configuration, as shown in FIG. 2B, the connecting section 101 is connected with the connecting section (not shown) and the external memory 100 is mounted so as to closely contact with the side face of the digital camera 1.

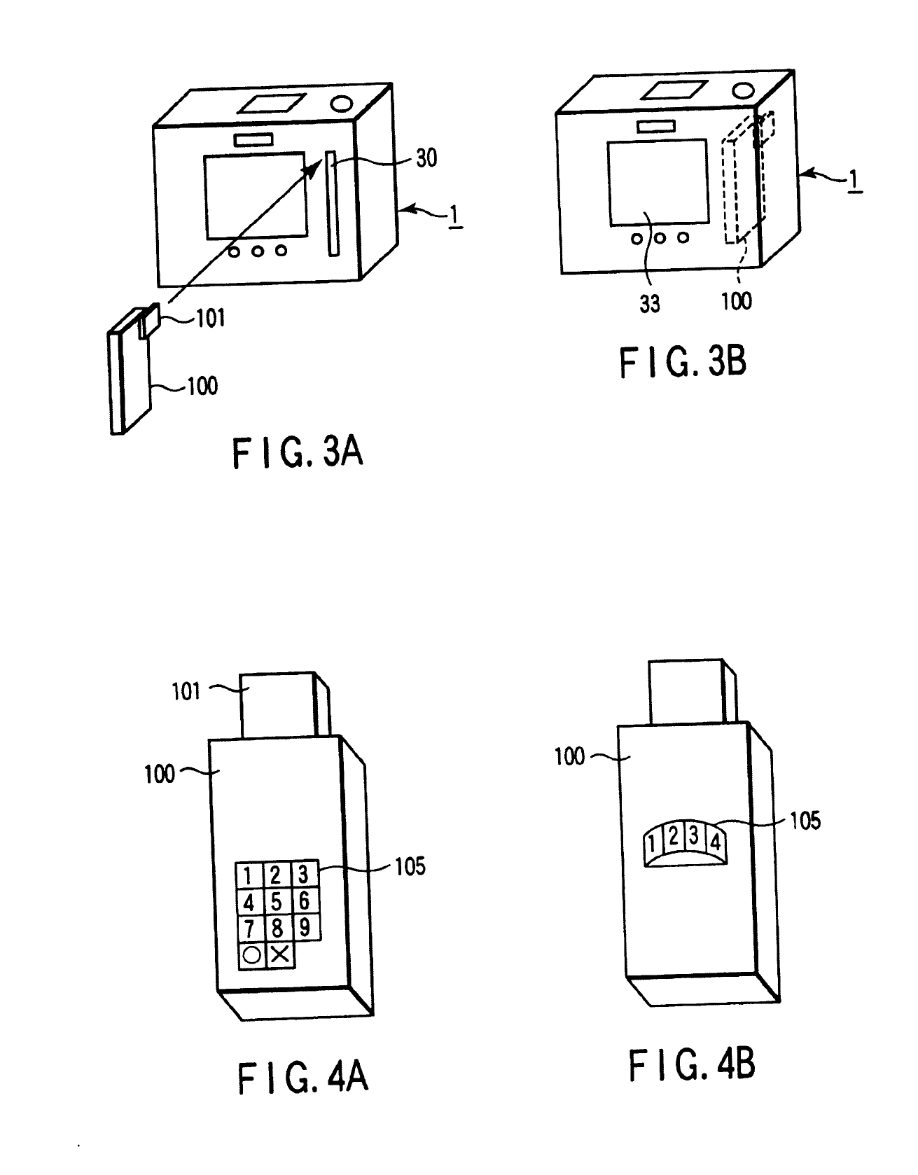

FIGS. 3A and 3B are views for explaining still another digital camera 1 to which the present invention is applied.

FIG. 3A shows an external configuration of still another digital camera 1 to which the present invention is applied, which is a perspective view showing a state in which the disconnectable external memory 100 is connected to the digital camera 1 from the back of the camera 1, viewed from the rear of the digital camera 1.

FIG. 3B is a perspective view showing a state in which the external memory 100 in FIG. 3A is connected into the digital camera 1, viewed from the rear of the digital camera 1.

That is, as shown in FIG. 3A, the inserting section 30 is set to the back of the digital camera 1.

Moreover, the connecting section 101 is protruded to the side face of the external memory 100 disconnectable from the digital camera 1.

Furthermore, a connecting section (not shown) connectable with the connecting section 101 is set in the digital camera 1.

In the case of the above configuration, as shown in FIG. 3B, the connecting section 101 is connected with the connecting section (not shown) and the external memory 100 is mounted so as to be completely included in the digital camera 1.

As shown in FIG. 3B, though the external memory 100 is set so as to be completely included in the digital camera 1, it is also allowed that a part of the external memory 100 protrudes to the outside of the digital camera 1.

As described above, it is enough that the digital camera 1 is electrically connected with the external memory 100 and therefore, it is allowed to use radio communication or optical communication.

Therefore, it is allowed that the digital camera 1 is connected to the external memory 100 in any way.

FIGS. 4A and 4B are views for explaining the external memory 100.

FIG. 4A is a perspective view showing an external memory 100 having a push-switch-type authentication-information input section as an external memory for use in a digital camera to which the present invention is applied.

FIG. 4B is a perspective view showing an external memory 100 having a dial-type authentication-information input section as an external memory for use in a digital camera to which the present invention is applied.

That is, as shown in FIG. 4A, the external memory 100 has an authentication-information input section 105 for inputting user authentication information (to be described later) such as an ID number and the like when it is connected to the digital camera 1.

The authentication-information input section 105 is configured by a push switch and a microcomputer (not shown) built in the external memory 100 detects the state of the push switch and user authentication information is input.

The authentication-information input section 105 is not restricted to the push switch shown in FIG. 4A. It is also allowed that the section 105 is configured by a dial as shown in FIG. 4B. In this case, an analog voltage or the like output correspondingly to a position set by the dial is A/D-converted by a circuit (not shown) in the external memory 100 and authentication information is input.

Moreover, it is allowed to use a fingerprint authentication system as the authentication-information input section 105.

Then, embodiments of the above digital camera to which the present invention is applied are described below.

(First Embodiment)

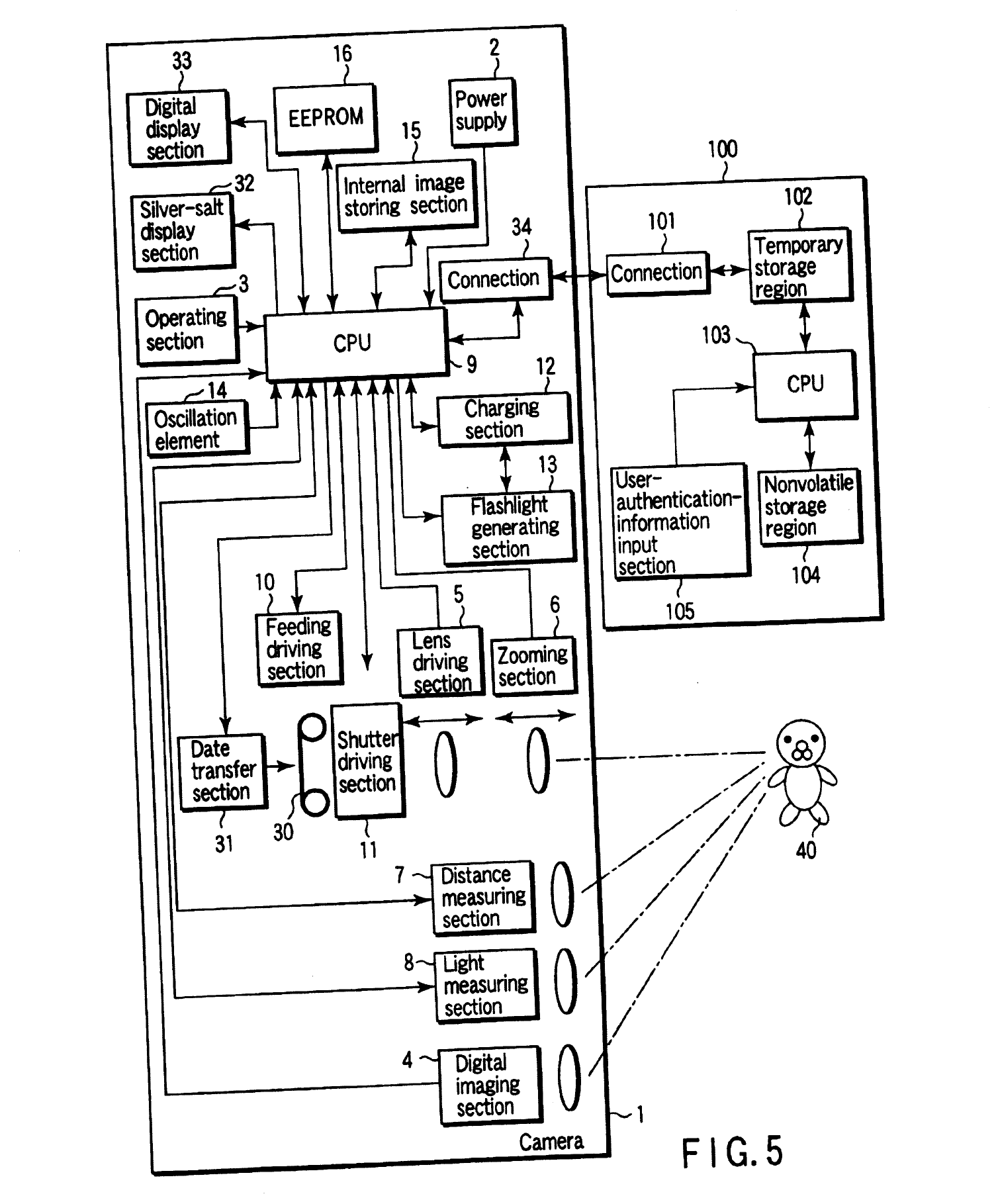

FIG. 5 is a block diagram shown to explain a connective configuration between the above digital camera 1 and external memory 100 as a first embodiment of a digital camera to which the present invention is applied.

That is, as shown in FIG. 5, a CPU 9 for controlling the digital camera 1 is arranged in the digital camera 1.

The CPU 9 connects with a power supply circuit 2 for supplying power to circuits of the camera including the CPU 9, an operating section 3 having a switch group, an digital imaging section 4 for imaging an object 40 as digital image data, a lens driving section 5 configured by a zoom lens, and a zooming section 6 for changing magnifications of the zoom lens.

The switch group of the operating section 3 includes a power switch, release switch, zoom-up switch, zoom-down switch, rear-lid switch, date-display-function switch, camera-mode-selecting-function switch, self-mode switch, photographing setting switch, user-information input key, and image display switch.

Moreover, the CPU 9 connects with a distance measuring section 7 for measuring the distance from the object 40, a light measuring section 8 for measuring the brightness of the object 40, a feeding driving section 10 configured by a feeding-motor driving circuit for feeding a film, a shutter driving section 11 configured by a shutter control circuit for controlling a shutter vane in a shutter unit, a flashlight generating section 13, a charging section 12 for storing the energy for making the flashlight generating section 13 generate flashlight, an oscillation element 14 for inputting an operating clock to the CPU 9, an internal image storing section (internal memory) 15 for storing digital data imaged by the digital imaging section 4, and a nonvolatile memory region (EEPROM) 16 for storing operation states of the camera.

Furthermore, the CPU 9 connects with a date transfer section 31 for transferring date data on a film 30 on which the image of the object 40 is focused, a silver-salt display section 32 for displaying the number of film frames and a camera mode when a silver halide film camera function is used, a digital display section 33 for displaying imaged digital image data, and a connecting section 34 serving as an interface for connecting with the external memory 100.

The external memory 100 has a CPU 103 for communicating with the CPU 9 and storing digital image data in a nonvolatile storage region.

The CPU 103 connects with a temporary storage region 102 for temporarily storing digital image data, a nonvolatile storage region 104 for storing digital image data and user authentication information, and a user-authentication-information input section 105 for inputting the user authentication information and the like.

The temporary storage region 102 connects with a connecting section 101 serving as an interface for electrically connecting the camera 1 with the external memory 100.

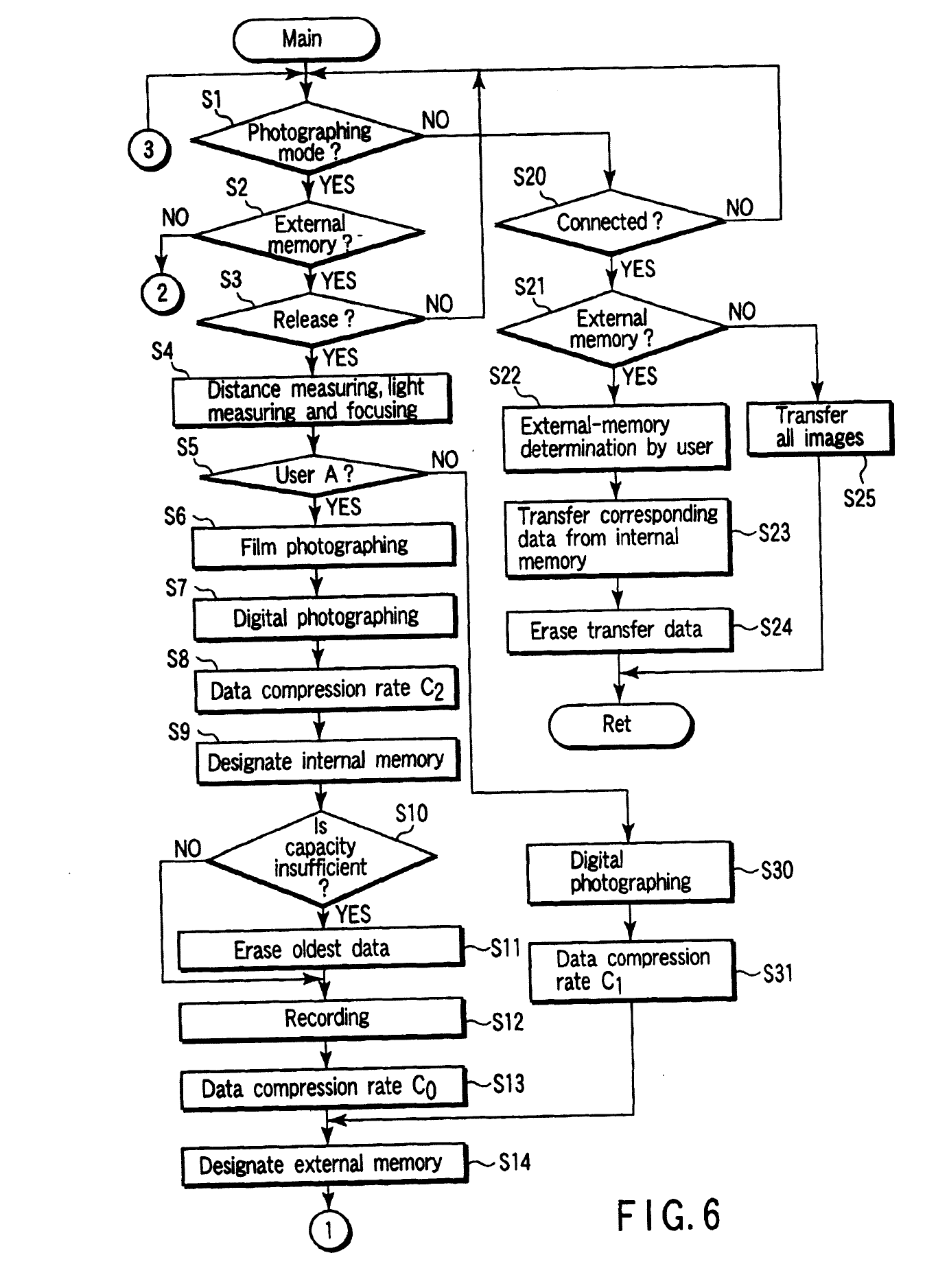

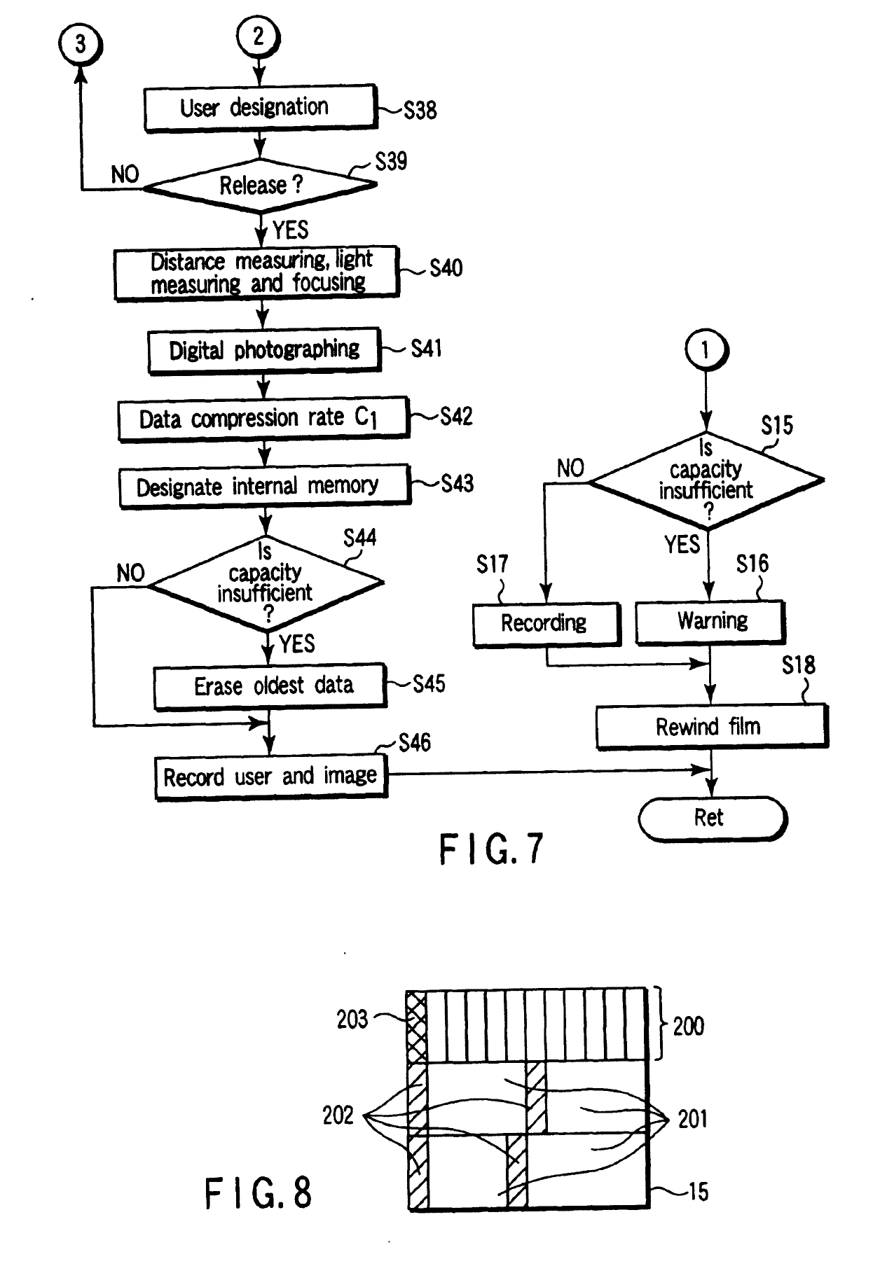

Then, operations of the digital camera of the first embodiment will be described below by referring to the flowcharts in FIGS. 6 and 7.

When the power switch of the operating section 3 of the digital camera 1 is turned on, it is determined whether or not the digital camera 1 is set to a photographing mode (step S1).

In this case, when the digital camera 1 is not set to the photographing mode, it is determined that the digital camera 1 is set to a transfer mode for transferring the image data stored in the internal memory 15 to the external memory 100. Therefore, the process is branched to step S20 to be described later.

When the digital camera 1 is set to the photographing mode, on the other hand, it is determined whether the external memory 100 is connected to the camera 1 (step S2).

In this case, when the external memory 100 is not connected, the process is branched to step S38 and an internal-memory photographing mode is set.

In step S38, user authentication information (user information) is input from the user-information input key of the operating section 3 of the digital camera 1 and user authentication is designated.

After the user authentication is designated, it is determined whether or not the release operation is performed by the release switch of the operating section 3 (step S39).

When the release operation is performed, distance measuring, photometry, and focusing are performed (step S40).

Then, digital photographing is performed (step S41).

The photographed digital image data is compressed at a predetermined compression rate Cl (step S42: Compression-rate change means).

The internal memory 15 is designated by the CPU 9 as a storage place of the compressed digital image data (step S43).

After the internal memory 15 is designated as a storage place, it is determined whether or not the storage capacity of the internal memory 15 is sufficient (step S44).

When it is determined that the storage capacity of the internal memory 15 is insufficient, the oldest digital image data of the digital image data stored in the internal memory 15 is erased (step S45).

However, it is assumed that a user photographs the image data to be kept for a long time by using the external memory 100 and the image data stored in the internal memory 15 is immediately transferred to the external memory 100 or the like.

Therefore, because the data at a high compression rate is stored in the internal memory 15 and the data at a lower compression rate is stored in the external memory 100, it is possible to shorten the shutter time lag from the time when photographing is once performed until the time when the next photographing can be performed.

Then, a configuration of the above internal memory 15 is described below by referring to FIG. 8.

That is, as shown in FIG. 8, the internal memory 15 is configured by a film-corresponding data section (the data in this part is compressed at a compression rate C2 higher than the compression rate C1: compression-rate change means) 200 for previewing an image photographed in a film before development, the above image-adding user authentication-information section 202, and an image data section 201 to and in which the image-adding user authentication information in the image-adding user-authentication-information section 202 is added and stored.

When the storage capacity of the internal memory 15 is sufficient in the above step S44 and the storage capacity of the internal memory 15 is sufficiently secured because the above digital image data is erased, image-adding user authentication information corresponding to the user authentication information is generated.

Then, the image-adding user authentication information is added to the digital image data and these pieces of information are stored in the internal memory 15 (step S46).

In this case, the flow of the internal-memory photographing mode is completed.

On the other hand, when it is determined in the above step S2 that the external memory 100 is connected, it is determined whether or not the release operation is performed (step S3).

When it is determined that the release operation is performed, distance measuring, photometry, and focusing are performed (step S4).

Thereafter, it is determined whether the present user is a specific user A having a camera using right (step S5).

Two pieces of information such as user authentication information (user information) and camera setting information are stored in the external memory 100 and in the case of the above determination, user authentication is performed by using the user authentication information stored in the external memory 100.

When it is determined that the present user is the user A, the camera setting information stored in the external memory 100 is set to the digital camera 1 (operation-state deciding section).

When the information for permitting the photographing using a film is stored in the camera setting information, photographing with a film is arbitrarily performed in accordance with the intention of the user A (step S6).

When the film photographing is performed, previewing digital photographing is simultaneously performed (step S7) and the digital image data C2 at a high compression rate is generated (step S8: compression-rate change section).

Then, the internal memory 15 is designated as a recording destination of the digital image data compressed at the compression rate C2 (step S9).

When the internal memory 15 is designated, it is determined whether or not the storage capacity of the internal memory 15 is sufficient (step S10).

When it is determined that the storage capacity of the internal memory 15 is insufficient, the oldest digital image data among the digital image data stored in the internal memory 15 is erased (step S11).

Subsequently, photographed digital image data is compressed at the compression rate C2 (compression-rate change section).

In this case, the compressed digital image data is stored in the internal memory 15 (step S12).

Because film photographing is performed by a user in the above step S6, it is determined that the photographing is high-image-quality-oriented photographing and digital image data is stored in not only the above internal memory 15 but also the external memory 100.

The digital image data is compressed at a compression rate C0 lower than the compression rate C1 (step S13: compression-rate change section).

The external memory 100 is designated as a storage destination of the compressed digital image data (step S14).

When the external memory 100 is designated as the storage destination, it is determined whether or not the storage capacity of the external memory 100 is sufficient (step S15).

When it is determined that the storage capacity of the external memory 100 is insufficient, a warning is displayed on a screen or an alarm is sounded as a warning for a user (step S16) and the digital image data compressed at the compression rate C0 is not stored in the external memory 100.

Because it is assumed that high-image-quality important digital image data is stored differently from the case of the internal memory 15, the old digital image data stored in the external memory 100 is not erased.

When the storage capacity of the external memory 100 is sufficient, the digital image data compressed at the compression rate C0 is stored in the external memory 100 (step S17).

After a film is rewound (step S18), a series of process flows is completed.

On the other hand, when it is determined in the above step S5 that the present user is not the user A but another user, the process is branched to step S30 and only digital photographing is performed (step S30).

Then, photographed digital image data is compressed at the data compression rate C1 (step S31: compression-rate change section).

Thereafter, the process is moved to step S14.

The order of the above compression rates are C0, C1, and C2 starting with the lowest one.

When it is determined in the above step S1 that the current mode is not a camera photographing mode, the connector connection of the external memory 100 to the connecting section 101 is detected (step S20).

In this case, it is determined whether the external memory 100 is connected to or a computer is connected to the connecting section 34 of the digital camera 1 (step S21).

When it is determined that the external memory 100 is connected to the connecting section 34, user authentication is performed in accordance with the user authentication information stored in the external memory 100 (step S22).

After the user authentication is performed, the user authentication information stored in the external memory 100 is compared with the image-adding user authentication information stored in each digital image data of the internal memory 15.

Only the digital image data having the image-adding user authentication information coinciding with the above user authentication information is transferred from the internal memory 15 to the external memory 100 (step S23).

In this case, the transferred digital image data is erased from the internal memory 15 (step S24) and then, a series of process flows is completed.

On the other hand, when it is determined in step S21 that a computer is connected to the connecting section 34 of the digital camera 1, all the digital image data in the internal memory 15 are transferred to the internal memory or external memory of the computer (step S25).

As described above, only the digital image data photographed by a user among the digital image data stored in the internal memory 15 is transferred to the external memory 100 of the user. Therefore, even when one digital camera is shared by a plurality of users, it is possible to transfer only necessary digital image data to the memory of each user, and store the data in the memory of each user.

Though the above external memory 100 is limited in storage capacity, it is possible to effectively use the external memory 100 because unnecessary digital image data is not transferred from the internal memory 15.

Setting portions of the photographing lens, flashlight generating section, and shutter button which are components of the digital camera to which the present invention is applied are not restricted to the above form. As long as a form can photograph an object image, the form of arrangement of components is not restricted.

According to a digital camera configured as described above, when it is determined that the external memory is connected, a user is determined in accordance with the user authentication information in the external memory.

Moreover, when it is determined that the external memory is connected, the setting of the digital camera is changed to the setting dedicated to a user in accordance with the user's utilization information in the external memory.

Therefore, only a specific user whose user authentication is confirmed can use a digital camera and thus, the safety is improved.

Moreover, a user can always use the digital camera having the setting dedicated to the user, it is not necessary to reset the digital camera whenever using it, and it is possible to operate even a digital camera used for the first time in accordance with the setting dedicated to the user without changing the setting.

The digital camera having the above configuration has silver halide film photographing means and permits the exposure operation in accordance with the user information stored in the external memory.

Therefore, only a user permitted in accordance with user information stored in the external memory can perform silver halide film photographing and thus, the safety is improved.

According to the digital camera configured as described above, only the digital image data in which the user authentication information included in the individual digital image data stored in the internal memory coincides with the user authentication information stored in the external memory is transferred to the external memory of an authenticated user.

Therefore, even when one digital camera is shared by a plurality of users, each user can easily transfer discrete digital image data to the external memory of an arbitrary user and use it.

The digital camera configured as described above changes compression rates of photographed image data and stores the data in the external memory.

Therefore, it is possible to store image data in an external memory with a compression rate desired by a photographer.

When the digital camera configured as described above determines that the external memory is connected, it stores photographed digital image data in the external memory and internal memory at arbitrary compression rates different from each other.

Accordingly, when the storage capacity of the internal memory is limited or an image at a high compression rate for thumbnail display is used, it is possible to correspond to various needs of users.

The digital camera configured as described above connects with a computer as the external memory of the camera to transfer digital image data to the built-in or external memory of the computer.

Therefore, even if a normal external memory is insufficient to photograph high-quality digital image data, it is possible to transfer and store a large amount of digital image data by connecting the digital camera with the external computer.

According to the digital camera configured as described above, when photographed digital image data is stored in the internal memory of the camera, if the storage capacity of the internal memory becomes insufficient, the digital image data stored in the internal memory is erased starting with the oldest digital image data.

When photographing with a digital camera having only a limited internal memory, therefore, it is possible to correspond to a photographing request of a user without missing a photo opportunity even if the storage capacity of the internal memory runs short.

Moreover, according to the digital camera of this embodiment, only a person having the right of using the digital camera can use predetermined functions of the digital camera, security is improved, and the same digital camera can be shared by a plurality of users.

(Second Embodiment)

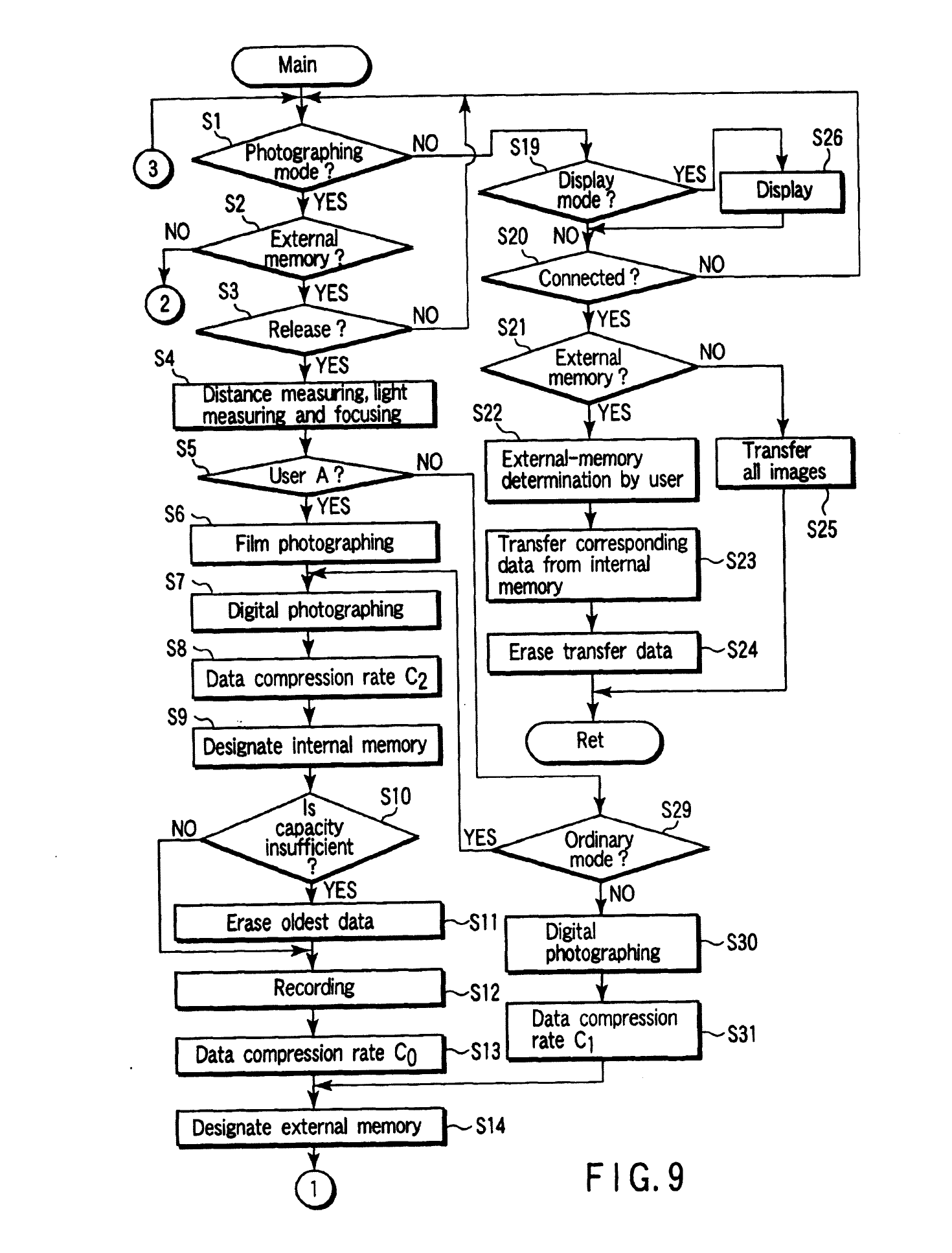

Then, operations of a digital camera of a second embodiment of the present invention will be described below by referring to the flowchart in FIG. 9.

It is assumed that the configuration of the digital camera of the second embodiment of the present invention is the same as the configuration of the first embodiment according to FIGS. 1A, 1B, 1C, FIGS. 2A, 2B, and 2C, FIGS. 3A and 3B, FIGS. 4A and 4B, and FIG. 5.

Moreover, in FIG. 9, process steps same as those of operations of the digital camera of the first embodiment shown in FIG. 6 are provided with the same step numbers and their descriptions are omitted.

Furthermore, the process flow of operations of the digital camera according to the first embodiment based on FIG. 7 is also applied to operations of the digital camera of the second embodiment.

In addition, in the configuration of the internal memory 15 according to FIG. 8, the film-corresponding-data section (data in this part is compressed at a compression rate C2 higher than the compression rate C1) 200 for previewing an image photographed on a film before the image is developed, image data section 201 in which the above-described image-adding user authentication information is added and stored), and preferential-display-image storage region 203 are applied to operations of the digital camera of the second embodiment.

In this case, the image data part 201 is stored at a low compression rate because it is an image not photographed on a film but having a high significance.

Moreover, first user authentication input in step S38 and data showing the sequence of photographed digital images are included in the image-adding user authentication information.

Furthermore, image data to be always displayed on display means such as an LCD of a camera (hereafter referred to as ordinary display image data) is stored in the preferential-display-image storage region 203.

When it is determined in the above step S5 that the present user is not the user A but another user, the process is branched from step S5 to step S29.

In this step S29, it is determined whether the current mode is a mode for photographing the image data to be stored in the preferential-display-image storage region 203 (hereafter referred to as ordinary mode).

In this case, when it is determined that the current mode is the ordinary mode, the process is branched to step S7.

From this step S7 and the subsequent steps, the above-described processes are executed.

When it is determined that the current mode is not the ordinary mode, on the other hand, digital photographing to be stored in the external memory 100 is performed in the above step S30 and then, the above-described processes are executed.

As described above, it is determined that the present user is not the user A or the current mode is not the ordinary mode, image data is stored in the external memory 100.

Moreover, when it is determined that the present move is not a camera photographing mode, it is determined that the current mode is a transfer mode for transferring the image data stored in the internal memory 15 to the external memory 100. Therefore, the process advances to step S19.

In this step S19, it is determined whether the current mode is a display mode in which the stored image data is displayed, or a transfer mode in which the stored image data is transferred.

When it is determined in this step S19 that the current mode is the display mode, the stored image data is displayed (step S26).

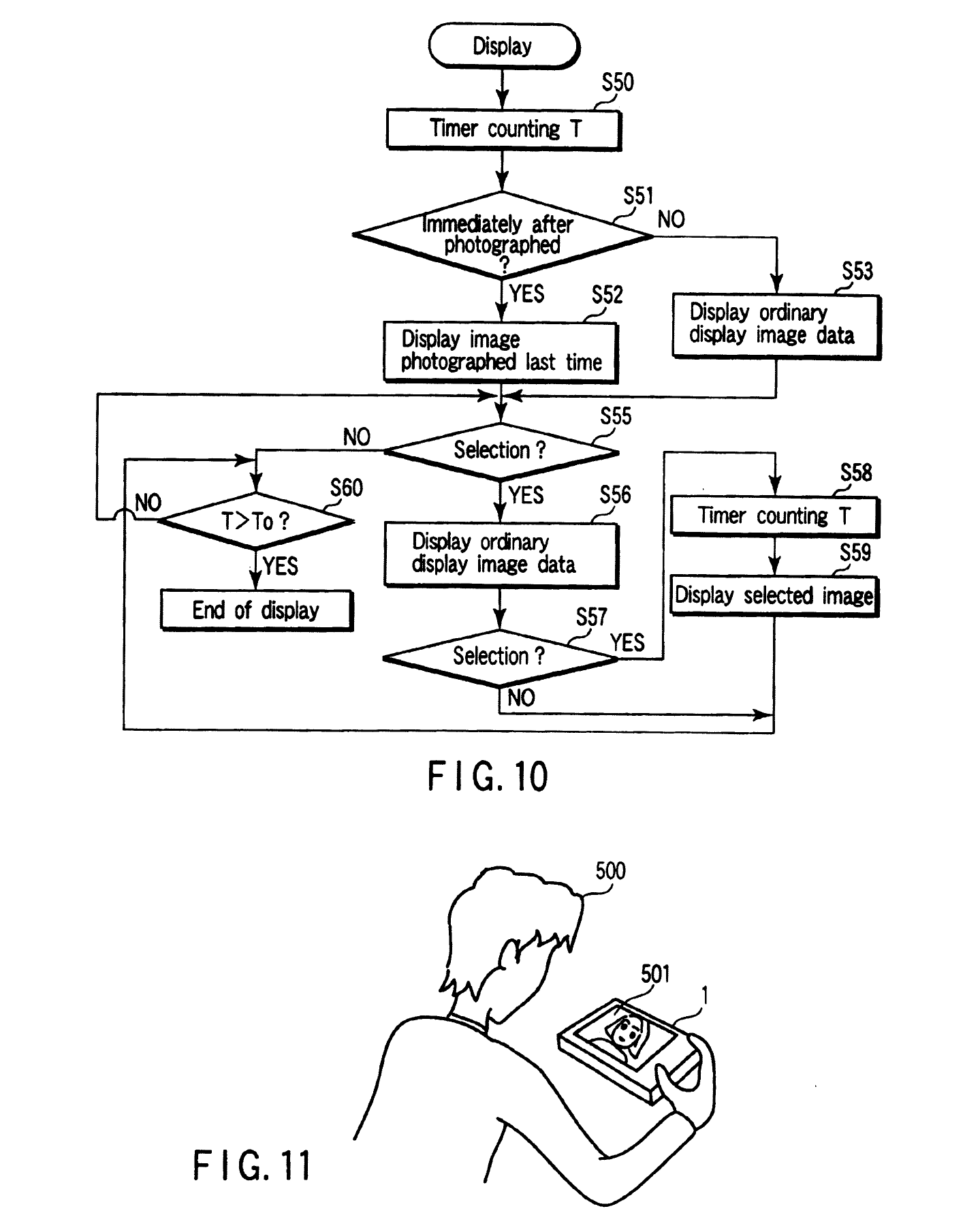

Display of image data will be described later by referring to FIG. 10.

When it is determined in step S19 that the current mode is not the display mode, on the other hand, processes same as those in the above steps S20 and S21 are executed.

When it is determined in step S21 that the external memory 100 is connected to the connecting section 34 of the digital camera 1, user authentication is performed in accordance with the second user authentication information stored in the external memory 100 (step S22).

After the user authentication is performed, the second user authentication information stored in the external memory 100 is compared with the image-adding user authentication information included in each digital image data in the internal memory 15.

Only the digital image data including the image-adding user authentication information coincided with the second user authentication information is transferred from the internal memory 15 to the external memory 100 (step S23).

The transferred digital image data is erased from the internal memory 15 (step S24) and then, a series of process flows is completed.

In this case, even when the ordinary display image data is transferred to the external memory 100, the ordinary display image data is left in the internal memory 15 because it is the image data to be always displayed.

Moreover, the stored image data is displayed in the above step S26. When the ordinary display image data in the internal memory 15 of the digital camera 1 is set to the display mode in the above step S19, it is preferentially displayed in step S26 of the display subroutine.

For example, as shown in FIG. 11, an owner 50 of the digital camera 1 can arbitrarily display the ordinary-display image data on an LCD (liquid-crystal display) 501 of the digital camera 1 to appreciate the data.

The ordinary display image data is always preferentially displayed differently from the image data for confirming a photographed image immediately after photographing the image.

Because the ordinary display image data is always displayed to decorate the digital camera 1 independently of whether or not the external memory 100 is connected, it is necessary to store the image data in the internal memory 15 of the digital camera 1.

There is an effect for making the owner of the camera have the feeling of commitment on the camera by always making the camera display the ordinary display image data.

Next, operations for displaying the ordinary display image data in the digital camera 1 will be described below by referring to the flowchart shown in FIG. 10.

To display the ordinary display image data, the timer for displaying the ordinary display image data is reset and counting for an arbitrary time T is started (step S50).

Then, it is determined whether or not the image data to be displayed is the image data immediately after photographed by the digital camera 1 (step S51).

When it is determined that the image data to be displayed is the image data immediately after photographed by the digital camera 1, the image data is displayed immediately before photographed by the camera in order to confirm whether the image data is photographed (step S52).

On the other hand, when it is determined that the image data is not the image data immediately after photographed by the digital camera 1, the image of the ordinary display image data is displayed (step S53).

Then, it is determined whether or not a selection switch for selecting a stored image is operated (step S55).

Here, when the selection switch is operated, the ordinary display image data is first preferentially displayed (step S56).

Further, it is determined whether or not the selection switch for selecting a stored image is operated (step S57).

In this case, when the selection switch is operated, the timer is restarted and counting for the arbitrary time T is performed (step S58). During the above period, the selected image is displayed (step S59 and the ordinary display image data is displayed until a predetermined time T0 (shorter than the arbitrary time T) elapses (step S60).

When the selection switch is not operated in step S55 or S57, on the other hand, the process is branched to S60, the ordinary display image data is displayed until the predetermined time T0 elapses (step S60), and then a series of process flows is completed.

As described above, in the case of this embodiment, even if one digital camera is shared by a plurality of users, important data is not erroneously erased by properly using the internal memory 15 and external memory 100 of the digital camera.

Also, in this embodiment, it is possible to user authentication is performed and convenience is improved only by connecting the external memory 100, security can be improved by allowing only a person having the right of using a digital camera to use predetermined functions of the digital camera, and use the same digital camera by a plurality of users without configuration.

Further, this embodiment makes it possible to provide a digital camera by which a user can always enjoy his favorite image.

Moreover, in this embodiment, important images are stored in the internal memory 15 without being erased even when setting or disconnecting the external memory 100 or lending the digital camera to other person.

Furthermore, though this embodiment conforms to a specification in which a person other than a user A of a digital camera can photograph the image as the ordinary image data, it is also allowed to use a specification in which only the user A can photograph the image as the ordinary image data.

In the case of the digital camera configured as described above, a user is recognized by only the fact that the user connects an external memory to the camera and it is permitted to store image data in an internal memory.

Therefore, according to the above digital camera, only a specified user whose user authentication is confirmed can use the internal memory of the digital camera and thus, the safety is improved.

The digital camera configured as described above is further provided with a display section for displaying an image and preferentially displays the data stored in an internal memory when displaying an image on the display section.

Therefore, this digital camera can easily display arbitrary image data stored in the internal memory to be displayed.

The digital camera configured as described above has a silver halide film photographing function in addition to a digital camera function.

According to the digital camera, therefore, a user can use the silver halide film photographing function in addition to the digital camera function.

In the case of the digital camera configured as described above, the permitted image data is stored in a preset predetermined storage region of the internal memory.

Therefore, according to this digital camera, it is possible to store image data to be displayed in the storage region of the internal memory.

In the case of the digital camera configured as described above, the internal memory has a preferential-display-image storage region for storing ordinary display image data.

According to the digital camera, therefore, it is possible to store image data to be displayed in a storage region dedicated to the internal memory.

The digital camera configured as described above arbitrarily displays ordinary display image data on the display of the digital camera.

Therefore, according to the digital camera, it is possible to display image data to be always displayed on the display of the digital camera.

As described above, according to the digital camera of the second embodiment of the present invention, important data is not erroneously erased by properly using the internal memory and external memory of the digital camera and moreover, user authentication can be performed only by connecting the external memory, the convenience is improved, and safety can be improved by making it possible for only a person having the right of using the camera to use predetermined functions of the camera, and the same digital camera can be shared by a plurality of users without confusion.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital camera from which an external memory capable of storing image data imaged by an imaging section is disconnectable, comprising:
a user-information reading section which reads user information previously stored in the external memory when the external memory is mounted; and
an operation-state deciding section which decides an operation state of the digital camera based on the user information read by the user-information reading section.

2. The digital camera according to claim 1, wherein the operation-state deciding section decides to perform user authentication when the external memory is mounted.

3. The digital camera according to claim 1, further comprising:
an internal memory capable of storing the image data imaged by the imaging section;
a transfer section which transfers the image data stored in the internal memory to the external memory; and
a comparing section which compares pieces of user information added to image data stored in the external memory and internal memory when the external memory is mounted,
wherein the operation-state deciding section decides image data to be transferred by the transfer section based on a comparison result by the comparing section.

4. The digital camera according to claim 3, wherein, when a comparison result that the pieces of user information coincide with each other is obtained by the comparing section, the transfer section transfers the image data to which coincided user information is added from the internal memory to the external memory.

5. The digital camera according to claim 1, wherein when storage capacity of the external memory is not sufficient, the image data imaged by the imaging section is not stored in the external memory.

6. The digital camera according to claim 5, further comprising:
a warning section which outputs a warning when the storage capacity of the external memory is not sufficient.

7. The digital camera according to claim 3, wherein, when storage capacity of the internal memory is not sufficient, predetermined image data stored in the internal memory is erased and then, the image data imaged by the imaging section is stored in the internal memory.

8. The digital camera according to claim 1, further comprising:
a compression-rate change section which changes a compression rate of the image data imaged by the imaging section by using the user information,
wherein the image data whose compression rate is changed by the compression-rate change section is stored in the external memory.

9. A digital camera from which an external memory capable of storing image data imaged by an imaging section is disconnectable, comprising:
an internal memory capable of storing the image data imaged by the imaging section; and
a control section which makes the external memory preferentially store the image data in a state in which the external memory is mounted.

10. The digital camera according to claim 9, further comprising:
a mode setting section which sets a predetermined mode; and
a permitting section which permits to store the image data in the internal memory in accordance with a mode set by the mode setting section.

11. The digital camera according to claim 9, further comprising:
a display section which displays the imaged data stored in the external memory or internal memory,
wherein the display section preferentially displays the image data stored in the internal memory.

12. The digital camera according to claim 9, wherein the external memory has an input section which inputs information concerning users.

13. The digital camera according to claim 12, wherein the input section is configured by a push switch.

14. The digital camera according to claim 12, wherein the input section is configured by a dial.

15. A digital camera from which an external memory capable of storing image data imaged by an imaging section is disconnectable, comprising:
an internal memory capable of storing the image data imaged by the imaging section;
a display section which displays the image data stored in the internal memory; and
a determining section which determines whether or not the image data imaged by the imaging section is image data immediately after imaged,
wherein, when the determining section determines that the image data is the image data immediately after imaged, the display section displays the image data imaged by the imaging section, and when the determining section determines that the image data is not the image data immediately after imaged, the display section displays ordinary display image data previously stored in the internal memory.

16. A digital camera from which an external memory capable of storing image data imaged by imaging means is disconnectable, comprising:
user-information reading means for reading user information previously stored in the external memory when the external memory is mounted; and
operation-means deciding means for deciding an operation state of the digital camera based on the user information read by the user-information reading means.

17. A digital camera from which an external memory capable of storing image data imaged by imaging means is disconnectable, comprising:
an internal memory capable of storing the image data imaged by the imaging means; and
control means for preferentially storing the image data in the external memory in a state in which the external memory is mounted.

18. A digital camera from which an external memory capable of storing image data imaged by imaging means is disconnectable, comprising:
an internal memory capable of storing the image data imaged by the imaging means;
display means for displaying the image data stored in the internal memory; and
determining means for determining whether or not the image data imaged by the imaging means is image data immediately after imaged,
wherein, when the determining means determines that the image data is the image data immediately after imaged, the display means displays the image data imaged by the imaging means, and when the determining means determines that the image data is not the image data immediately after imaged, the display means displays ordinary image data previously stored in the internal memory.

19. A method of controlling a digital camera from which an external memory capable of storing image data imaged by imaging means is disconnectable, comprising:
reading user information stored in the external memory when the external memory is mounted; and
deciding an operation state of the digital camera based on the user information read from the external memory.

20. A method of controlling a digital camera from which an external memory capable of storing image data imaged by imaging means is disconnectable, comprising:
preparing an internal memory capable of storing the image data imaged by the imaging means; and
preferentially storing the image data in the external memory in a state in which the external memory is mounted.

21. A method of controlling a digital camera from which an external memory capable of storing image data imaged by imaging means is disconnectable, comprising:
preparing an internal memory capable of storing the image data imaged by the imaging means;
displaying the image data stored in the internal memory;
determining whether or not the image data imaged by the imaging means is image data immediately after imaged;
when it is determined that the image data is the image data immediately after imaged, displaying the image data imaged by the imaging means; and
when it is determined that the image data is not the image data immediately after imaged, displaying ordinary display image data previously stored in the internal memory.
